(19) United States
(12) Patent Application Publication
(10) Pub. No.: US 2006/0176835 A1
(43) Pub. Date: Aug. 10, 2006

(54) System and method for providing internet protocol based broadcast services

(75) Inventors: Soon-Ho Jang, Seongnam-si (KR); Chang-Sup Shim, Seoul (KR); Yun-Je Oh, Yongin-si (KR); Tae-Sung Park, Yongin-si (KR); Seong-Ha Kim, Yongin-si (KR); Se-Hong Park, Suwon-si (KR); Yu-Gun Kim, Ansan-si (KR); Dong-Il Seo, Suwon-si (KR); Jung-Hwan Lim, Suwon-si (KR); Jun-Sung An, Suwon-si (KR); Sung-Il Sohn, Seoul (KR); Se-Kang Park, Seongnam-si (KR); Do-Young Joung, Seoul (KR); Su-Hyung Kim, Seoul (KR); Gil-Yong Park, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/340,967

(22) Filed: Jan. 26, 2006

(30) Foreign Application Priority Data
Feb. 7, 2005 (KR) 2005-11194

(51) Int. Cl. H04L 12/56; H04Q 11/00; H04L 12/16; H04L 12/28

(52) U.S. Cl. 370/270; 370/408; 370/389

(57) ABSTRACT

A solution for allowing conditional access to IP-based broadcast services in a passive optical network is disclosed. When a subscriber requests broadcast services by selecting a broadcast channel, an IP set-top converts the request into an IGMP join message and forwards the message to an ONU/ONT, a unit on the subscriber's side. The ONU/ONT delivers the message to an OLT interworking with a router while storing mapping information of the port that received the message and a MAC address of the selected channel. Thereafter, the OLT extracts information on MAC address of the IP set-top box and the requested broadcast data. The OLT compares the extracted information to the subscriber's subscription information and determines whether to provide the requested broadcast services. If the broadcast services may be provided, the broadcast data provided from the broadcast server is transmitted to the IP set-top box via ONU/ONT based on the stored mapping information.

### CLAIM OF PRIORITY

This application claims priority to an application entitled “System and Method for Providing Internet Protocol Broadcast Services,” filed with the Korean Intellectual Property Office on Feb. 7, 2005 and assigned Serial No. 2005-11194, the contents of which are incorporated herein by reference.

### BACKGROUND OF THE INVENTION

1. Field of the Invention

The present invention relates to a system and method for providing broadcast services, and more particularly to a system and method for providing Internet protocol broadcast services through a passive optical network.

2. Description of the Related Art

Generally, IP-based broadcast networks need data transmission rates in excess of 100 Mbps in order to effectively provide subscribers with large-amount, high-speed data services and real-time digital broadcast/video services. Existing broadband technologies, such as xDSL and cable modems with merely up to 50 Mbps transmission rate, cannot meet the demand for higher bandwidths to offer such data services. Thus, studies are actively pursuing the development of high-speed. data transmission networks capable of providing high-speed, large-amount data services and real-time digital broadcast/video services. As alternative technology for transmitting data at higher rate, optical networks, particularly the cost-effective passive optical networks (PONs) are attracting attention of the industry.

There are various PONs which include an ATM-based PON (ATM-PON), a wavelength division multiplexed PON (WDM-PON) and an Ethernet-based PON (EPON). As an economical solution to bring high-speed fiber optic services to homes, an FTTH (Fiber To The Home) architecture of the EPON has been suggested.

Current IP-based broadcast networks encode broadcast signals from a satellite receiver connected to a broadcast TV headend or from a content/program provider into MPEG2/4 or H.264 frames to provide video services to the subscriber terminals. Each subscriber can receive video data at a selected channel through an IP set-top box (“STB”) connected to a TV receiver or a computer at the subscriber's home.

A process of providing IP-based broadcast services using a general IGMP (Internet Group Management Protocol) will be explained with reference to FIG. 1. The term “IP-based broadcast services” is supposed to have the same meaning as “IP-based TV services.”

Referring to FIG. 1, to provide IP-based TV services using a PON, a broadcast signal coming from a content/program provider is converted into an MPEG2/4 stream at a broadcast server which is a TV headend, and transmitted to the subscriber terminals through an OLT (Optical Line Terminal), which is an L2 or L3 switch and IP set-top boxes (STBs) connected to the subscriber network consisting of ONUs (Optical Network Units) or ONTs (Optical Network Terminals).

When a user selects a specific channel at step 100, a corresponding IP set-top box (STB) sends an IGMP join message to the broadcast server (i.e., headend). When an ONU/ONT receives the IGMP join message from the IP set-top at step 100, it delivers the message to the OLT. Thereafter, the ONU/ONT stores a port that received the message and a multicast group MAC address in a mapping table at step 102. Upon receiving the message from the ONU/ONT, the OLT analyzes the message and sends multicast group data provided from the broadcast server (i.e., requested broadcast data) to the ONU/ONT at step 104.

The ONU/ONT sends the broadcast data received from the OLT to the port that has requested the data (i.e., the corresponding IP set-top box) at step 108 by reference to the information stored in the mapping table.

At step 110, the IP set-top box extracts an MPEG2/4 stream from the received data and delivers the extracted stream to a TV or PC broadcast receiving card.

In current satellite TV or CATV service networks, all broadcasting signals are transmitted to each ONT. Thus, service providers encrypt the channels according to their conditional access scheme and allow each subscriber to decode and view only the subscribed channels using an authentication card (a POD module) in the set-top box and receive broadcast services on the decoded channels.

The IP-based broadcast networks, however, provide video data of a channel selected by a subscriber using the IGMP protocol that does support authentication-based controlled access. In these networks, it is actually impossible to control access to the broadcast services by subscribers. In addition, it is difficult to charge different fees according to the services used by each subscriber because no authentication is performed at the IP set-top box to verify the subscriber's right to access during a change of channel.

As a solution to the above problems, a suggestion has been made to use techniques for encrypting channels, as in the existing CATV networks, and allowing only the subscribers authorized to access broadcast services through authentication.

However, the IP set-top box that receives the encrypted video data has to decode the data with increased overhead, which results in the increase in channel zapping time (i.e., time to change channels).

### SUMMARY OF THE INVENTION

Accordingly, the present invention has been made to solve the above-mentioned problems occurring in the prior art and provides additional advantages, by providing a system and method for allowing conditional access to IP-based broadcast services provided through a passive optical network based on subscription information of a subscriber who requested the broadcast services.

In accordance with one aspect of the present invention, a system for providing IP-based broadcast services through a passive optical network is provided. The system includes: a broadcast server for providing broadcast data; an IP set-top box for sending an IGMP join message to the broadcast server when a channel is selected; an ONU/ONT for delivering the message received from the IP set-top box to an OLT, storing a mapping table containing mapping information of a port that received the message and a multicast group MAC address, and when receiving broadcast data from the OLT, sending the broadcast data to the IP set-top box (IGMP snooping); and the OLT for databasing information about each user's subscription to the broadcast services, and when receiving the IGMP join message, allowing conditional access to the broadcast data provided from the broadcast server based on the subscription information.

In accordance with another aspect of the present invention, a method for providing IP-based broadcast services through a passive optical network is provided. The method includes a broadcast server for providing broadcast data and an OLT for transporting the broadcast data provided from the broadcast server to each user through an ONU/ONT and an IP set-top box, which comprises the steps of: databasing information about each user's subscription to the broadcast services at the OLT; when a channel is selected, sending an IGMP join message from the IP set-top box to the ONU/ONT; when the ONU/ONT receives the IGMP join message, transmitting the message to the OLT and storing mapping information of a port that received the message and a multicast group MAC address; when the OLT receives the IGMP join message from the ONU/ONT, comparing the message with the subscription information to determine whether broadcast services may be provided to the IP set-top box that has sent the IGMP join message to request the data; when the OLT determines that the broadcast services may be provided to the IP set-top box, sending the broadcast data provided from the broadcast server to the ONU/ONT; and sending the broadcast data from the ONU/ONT to the IP set-top box according to the stored mapping information.

### BRIEF DESCRIPTION OF THE DRAWINGS

The above features and advantages of the present invention will be more apparent from the following detailed description taken in conjunction with the accompanying drawings, in which:

FIG. 1 illustrates a process of providing IP-based broadcast services using a general IGMP protocol;

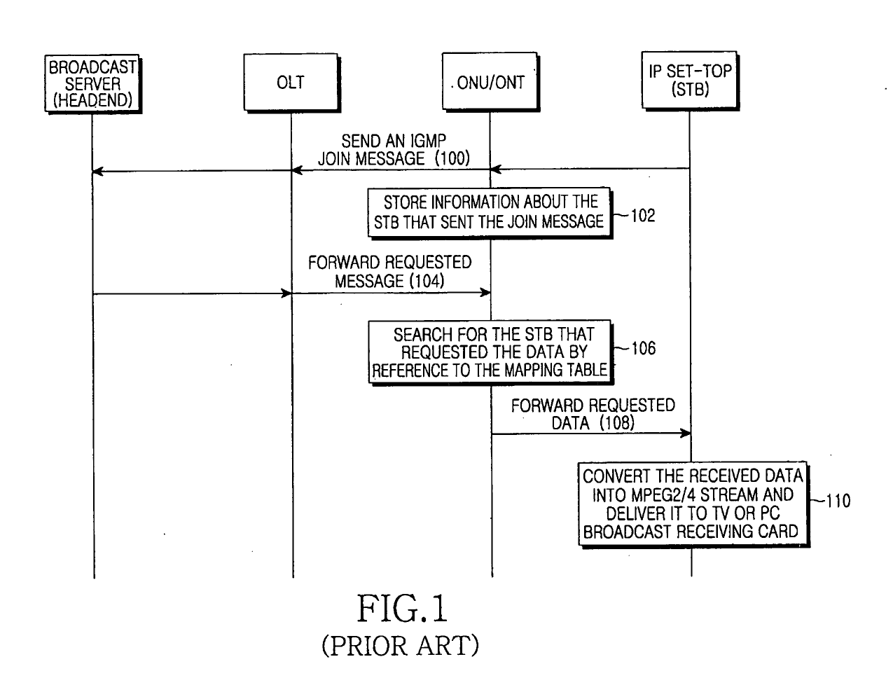

FIG. 2 illustrates an Ethernet-based passive optical network according to the present invention;

FIG. 3 illustrates a process of providing IP-based broadcast services using an IGMP protocol and user's subscription information according to the present invention;

FIG. 4 is a flow chart showing a process of providing IP-based broadcast services using an IGMP protocol in an OLT based on user's subscription information according to the present invention; and

FIG. 5 is a flow chart showing a process of providing IP-based broadcast services using an IGMP protocol in an ONU/ONT based on user's subscription information according to the present invention.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

The present invention provides a method for allowing conditional access to IP-based broadcast services provided through a passive optical network (“PON”) according to subscription information of a subscriber who requested for the broadcast services. Particularly, the present invention provides a conditional access solution to control each subscriber's access to broadcast services provided through an Ethernet-based PON.

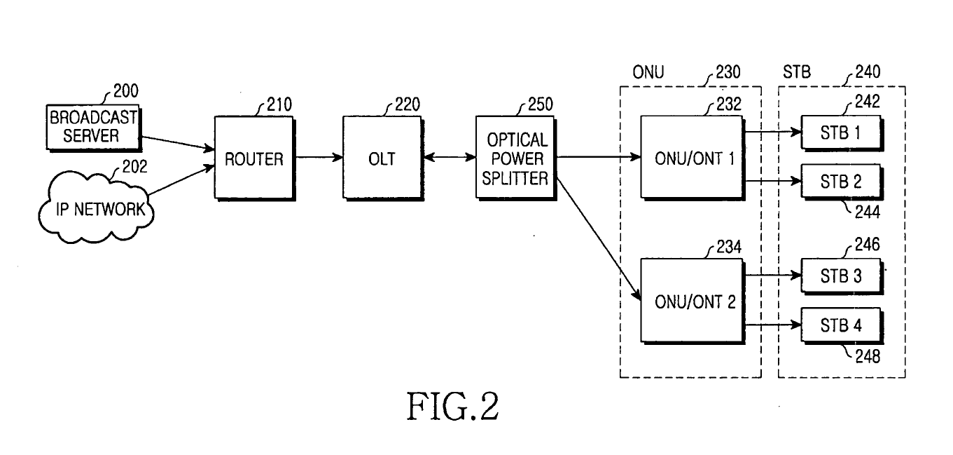

FIG. 2 illustrates an Ethernet-based PON according to the present invention.

Referring to FIG. 2, the Ethernet-based PON comprises an OLT (Optical Line Terminal) 220 which is a sub-system located between end users and a service node to combine a broadcast signal received from a broadcast service provider and a communication signal received from a communication service provider into a single optical signal after an electric-optical conversion, a plurality of ONUs or ONTs (Optical Network Units or Optical Network Terminals) 230 which are user-side units for delivering information received from the OLT 220 to the end users through IP set-top boxes (STBs) 240 and an optical power splitter 250 connecting the OLT 220 to the plurality of ONUs or ONTs. The Ethernet-based PON may also include a router 210 that couples the OLT 220 to a broadcast server 200 and IP network 202.

The broadcast server (headend) 200 converts broadcast signals provided from program providers into MPEG2/4 streams or H.264 frames by channels and transmits broadcast data encapsulated into IP packets. The broadcast data is transmitted to the subscribers who have requested broadcast services on specific channels through an IGMP protocol.

The OLT (Optical Line Terminal) 220 controls registration and management of the plurality of subscriber units (ONUs or ONTs) 230 through 802.3ah protocol. The OLT 220 also controls transmission and receiving of broadcast data offered from the broadcast server 200. In order to conditionally provide the broadcast data, the OLT 220 stores user (subscriber) information as to which channels each user has subscribed to.

In this connection, the OLT 220 may request the broadcast server 200 to provide subscriber information and store the information received from the broadcast server 200. Alternatively, the OLT 220 may establish its own subscriber information database. In the former case, a separate channel is additionally needed to receive and store the subscriber information. The subscriber information can be stored or managed using a separate RADIUS server. In case of customer premise equipment such as the ONTs, it is possible to store the subscriber's subscription information using the MAC address or LLID (Logical Link ID) of the ONT.

Each ONU/ONT 230 receives or transmits data from or to an exterior network using 802.3ah protocol according to the bandwidth assigned by the OLT 220. Also, each ONU/ONT 230 manages broadcast data received from the broadcast server 200 using IGMP snooping which is an L2function.

The IP set-top boxes 240 connected to the ONUs or ONTs 230 are connected to TV receivers at homes or offices and convert the received broadcast data into broadcast signals. When a user changes channel, a corresponding ONU or ONT 230 receives video data of the newly selected channel using the IGMP protocol and transmits the received data to the user's TV or PC.

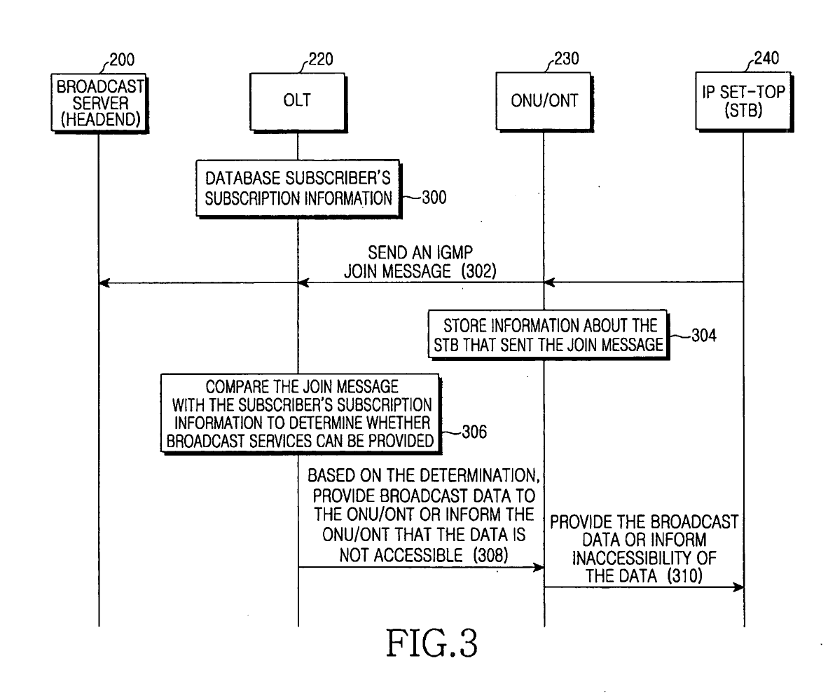

Hereinafter, a method for controlling a user's access to IP-based broadcast services provided through an Ethernet-based PON (which is illustrated in FIG. 2) according to the user's subscription information will be explained with reference to FIG. 3. FIG. 3 illustrates a process of providing IP-based broadcast services using the IGMP protocol according to the present invention.

The OLT 220 databases broadcast service subscription information of each ONU/ONT 230 or the IP set-top box connected thereto at step 300. In other words, the OLT 220 stores a MAC address or an LLID (Logical Link Identification defined in 802.3ah) of each ONU/ONT 230 or a MAC address of the connected IP set-top box 240, together with information about subscribed channels. The broadcast service subscription information of each user can be databased using one of the methods explained with reference to FIG. 2.

When a user selects a channel, the IP set-top box 240 sends an IGMP join message to the broadcast server 200 at step 302. The ONU/ONT 230 receives the IGMP join message and delivers the message to the OLT 220. Then, the ONU/ONT 230 stores a mapping table of a port that received the message and a multicast MAC address.

Upon receiving the IGMP join message from the ONU/ONT 230, the OLT 220 compares the received message with the databased subscription information to determine whether broadcast services may be provided to the IP set-top box that has sent the IGMP join message or to the ONU/ONT.

If the OLT 220 determines that the broadcast services may be provided, the OLT 220 sends the broadcast data provided from the broadcast server 200 to the corresponding ONU/ONT 230. Otherwise, the OLT 220 discards the received IGMP join message and sends the ONU/ONT 230 a non-authentication message converted into 802.3ah based OAM frames to inform that the requested broadcast services are not accessible because the authentication is not made.

The ONU/ONT 230 receives the broadcast data or non-authentication message sent by the OLT 220 at step 308 and delivers the received data or message to the IP set-top box 240 at step 310. In particular, if the ONU/ONT 230 receives the broadcast data from the OLT 220, the ONU/ONT 230 delivers the received data to the corresponding IP set-top box 240 that has requested the data based on the mapping table stored at step 304. If the ONU/ONT 230 receives a non-authentication message from the OLT 220, the ONU/ONT 230 removes information about the requested broadcast data (multicast group) from the mapping table.

If the broadcast data is received through the ONU/ONT 230, the IP set-top box 240 extracts and decode MPEG2/4 or H.264 frames from the received broadcast data and transmits the decoded data to a TV or PC broadcast receiving card. On the other hand, if the non-authentication message is received, the IP set-top box 240 transmits data informing that the broadcast services are not accessible to the TV or PC broadcast receiving card. At this time, a newly defined message or a message typically used when receiving an authentication key for each channel from the broadcast server can be used to inform the inaccessibility of broadcast services

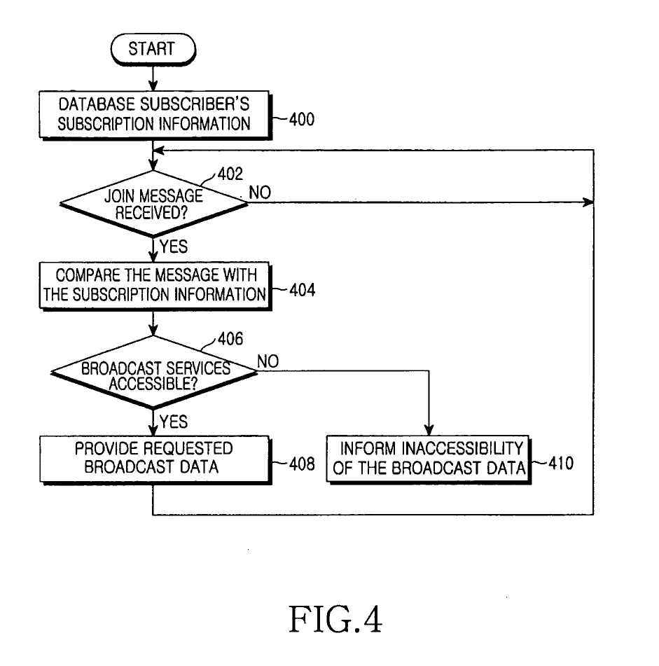

Hereinafter, a process of providing IP-based broadcast services using the IGMP protocol in the OLT based on user's subscription information according to the present invention will be explained in detail with reference to FIG. 4.

At step 400, the OLT 220 databases user subscription information concerning channels that each user subscribed to. As explained in conjunction with FIG. 2, a separate channel can be provided to request and receive subscriber information from the broadcast server 200. Alternatively, the OLT 220 may establish its own subscriber information database or use a separate authentication server.

When the OLT 220 receives an IGMP join message from an ONU/ONT 230 at step 402, it proceeds with step 404 to compare the received message with the subscription information databased at step 400 and determine whether broadcast services may be provided to the IP set-top box that has sent the IGMP join message or to the ONU/ONT.

If the OLT 220 determines that the broadcast services may be provided, the OLT 220 proceeds with step 408 to send the requested broadcast data to the ONU/ONT 230. If the OLT 220 does not receive the broadcast data of the selected channel from the broadcast server, the OLT 220 requests the broadcast server to provide the data, and upon receiving the data from the broadcast server, the OLT 220 sends the data to the subscriber.

If the OLT 220 determines that the broadcast services may not be provided, the OLT 220 proceeds with the step 410 to discard the received IGMP join message. In addition, the OLT 220 sends the ONU/ONT 230 a non-authentication message converted into 802.3ah based OAM frames to inform them that the requested broadcast services are not accessible because the authentication is not made.

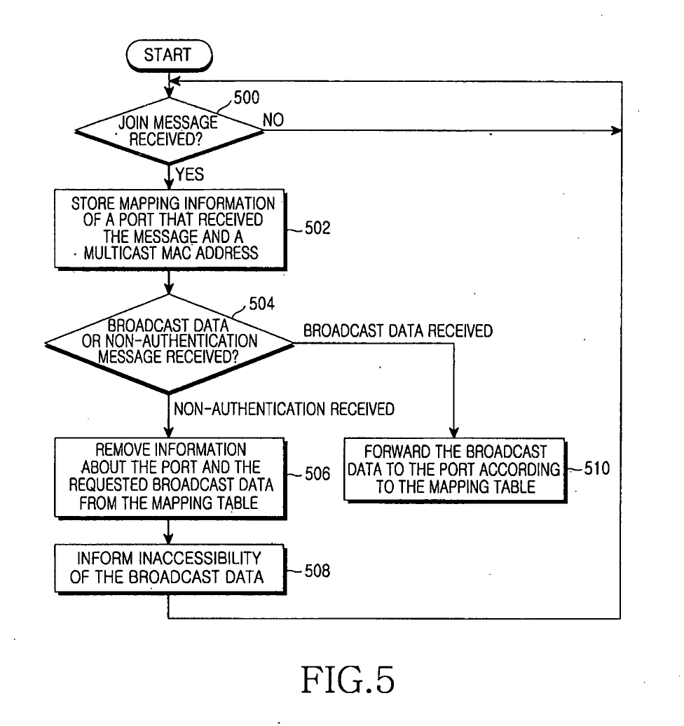

Hereinafter, a process of providing IP-based broadcast services using the IGMP protocol in an ONU/ONT based on user's subscription information according to the present invention will be explained in detail with reference to FIG. 5.

When the ONU/ONT 230 receives an IGMP join message from the IP set-top box 240 at step 500, the ONU/ONT 230 stores mapping information of a port that received the message and a multicast group MAC address in a mapping table at step 502. In addition, the ONU/ONT 230 sends the received message to the OLT 220.

Upon receiving the IGMP join message from the ONU/ONT 230 at step 504, the OLT 220 proceeds with step 510 to send the requested broadcast data to the port that has sent the join message.

If the ONU/ONT 230 receives a non-authentication message informing that broadcast services are not accessible from the OLT 220, the ONU/ONT 230 proceeds with step 506 to remove information about the port and the requested broadcast data (multicast group) from the mapping table. Thereafter, the ONU/ONT 230 proceeds with step 508 to inform the IP set-top box 240 that the broadcast services are not accessible.

As explained above, the present invention provides a system and method for allowing conditional access to IP-based broadcast services in a passive optical network based on the user's subscription information. In other words, each user may access only the services and contents of subscribed channels.

Access to the IP-based broadcast services can be controlled based on the user's subscription information without any conversion of the IGMP protocol generally used in existing IP-based broadcast networks. Since users may access only subscribed broadcast channels, it is possible to charge different fees according to the broadcast services used by each user. In a conventional encryption/decryption scheme for controlled access, IP set-top boxes have to decrypt the encrypted channels to receive broadcast data. This decryption process increases overhead in the set-top boxes and results in the increase in channel zapping time (i.e., time to change channels). The present invention can reduce the zapping time. When there is a change in broadcast services to which a user subscribed, only the subscriber information database needs be updated to rapidly provide subscribed broadcast services to the user.

Although preferred embodiments of the present invention have been described for illustrative purposes, those skilled in the art will appreciate that various modifications, additions and substitutions are possible, without departing from the scope and spirit of the invention. Although conditional access to broadcast services in an Ethernet-based passive optical network has been explained, the present invention is applicable to any passive optical networks based on ATM (Asynchronous Transfer Mode) or WDM (Wavelength Division Multiplexing). Therefore, this invention is not to be unduly limited to the illustrative embodiments set forth herein and various modifications, additions and substitutions are possible, without departing from the scope and spirit of the invention as disclosed in the accompanying claims, including the full scope of equivalents thereof.

What is claimed is:

1. A system for providing IP-based broadcast services through a passive optical network, comprising:
a broadcast server (headend) for providing broadcast data;
an IP set-top box for sending an IGMP join message to the broadcast server when a channel is selected;
an ONU/ONT for delivering the message received from the IP set-top box to an OLT, storing a mapping table containing mapping information of a port that received the message and a multicast group MAC address, and when receiving broadcast data from the OLT, sending the broadcast data to the IP set-top box; and
the OLT for databasing information about each user's subscription to the broadcast services, and when receiving the IGMP join message, allowing conditional access to the broadcast data provided from the broadcast server based on the subscription information.

2. The system as claimed in claim 1, wherein said OLT, when determining that the broadcast data cannot be provided, discards the received IGMP join message and sends a non-authentication message informing that the broadcast data is not accessible to the ONU/ONT because the authentication is not made.

3. The system as claimed in claim 2, wherein said ONU/ONT, when receiving the non-authentication message from the OLT, removes information about the port and the requested broadcast data from the mapping table and informs the IP set-top box that the broadcast data is not accessible.

4. The system as claimed in claim 1, wherein said information about user's subscription to the broadcast services includes a MAC address or 802.3ah based LLID (Logic Link Identification) and subscribed broadcast channels of the ONU/ONT.

5. The system as claimed in claim 1, wherein said OLT requests the broadcast server to provide user's subscription information and stores the subscription information upon receipt from the broadcast server.

6. The system as claimed in claim 1, wherein said OLT establishes a subscriber's subscription database within the OLT system or using a separate server.

7. The system as claimed in claim 1, further comprising an optical power splitter disposed between the OLT and the ONU/ONT.

8. The system as claimed in claim 1, further comprising a router disposed between the OLT and the broadcast server.

9. The system as claimed in claim 1, wherein the OLT assigns a bandwidth of the ONU/ONT.

10. The system as claimed in claim 1, wherein the ONU/ONT manages the broadcast data received from the broadcast server using IGMP snooping, an L2 function.

11. A method for providing IP-based broadcast services through a passive optical network comprising a broadcast server for providing broadcast data and an OLT for transporting the broadcast data provided from the broadcast server to each user through an ONU/ONT and an IP set-top box, the method comprising the steps of:
databasing information about each user's subscription to the broadcast services at the OLT;
sending an IGMP join message from the IP set-top box to the ONU/ONT when a channel is selected;
transmitting the message to the OLT and storing a mapping table containing mapping information of a port that received the message and a multicast group MAC address when the ONU/ONT receives the IGMP join message;
comparing the message with the subscription information to determine whether broadcast services may be provided to the IP set-top box that has sent the IGMP join message to request the data when the OLT receives the IGMP join message from the ONU/ONT;
sending the broadcast data provided from the broadcast server to the ONU/ONT when the OLT determines that the broadcast services may be provided to the IP set-top box; and
sending the broadcast data from the ONU/ONT to the IP set-top box according to the stored mapping information.

12. The method as claimed in claim 11, further comprising the steps of discarding the received IGMP join message and sending a non-authentication message informing that the requested broadcast data is not accessible to the ONU/ONT when said OLT determines that the broadcast services may not be provided.

13. The method as claimed in claim 12, further comprising the steps of removing information about the port and the requested broadcast data from the mapping table and informing the IP set-top box that the broadcast data is not accessible when said ONU/ONT receives the non-authentication message from the OLT.

14. The method as claimed in claim 11, further comprising the steps of including a MAC address and subscribed broadcast channels of the ONU/ONT to said information about user's subscription to the broadcast services.

15. The method as claimed in claim 11, wherein the step for databasing information about each user's subscription to the broadcast services at the OLT further comprises the steps of databasing the information about user's subscription to the broadcast services by requesting the broadcast server to provide user's subscription information and storing the subscription information upon receipt from the broadcast server.

16. The method as claimed in claim 11, wherein the step for databasing information about each user's subscription to the broadcast services at the OLT further comprises the steps of databasing the information about user's subscription to the broadcast services by establishing a subscriber's subscription database within the OLT system or using a separate server.

17. The method as claimed in claim 11, further comprising the steps of disposing an optical power splitter between the OLT and the ONU/ONT.

18. The method as claimed in claim 11, further comprising the steps of disposing a router between the OLT and the broadcast server.

19. The method as claimed in claim 11, further comprising the steps of controlling the bandwidth of the ONU/ONT with the OLT.

20. The method as claimed in claim 11, further comprising the steps of managing broadcast data received from the broadcast server using IGMP snooping, an L2 function, with the ONU/ONT.
